(19) United States
(12) Patent Application Publication
(10) Pub. No.: US 2006/0034491 A1
(43) Pub. Date: Feb. 16, 2006

(54) System for visualising a surface structure

(76) Inventor: Manish Sharma, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/919,452

(22) Filed: Aug. 16, 2004

(51) Int. Cl. G06K 9/00

(52) U.S. Cl. 382/108

(57) ABSTRACT

The present invention provides a system for visualising a surface structure of an object. The system includes a camera for taking a plurality of images of the object and a location monitor for monitoring a respective location associated with each image that the camera takes. The system also includes a micro-processor, a display for displaying the surface structure of the object and a software routine for the micro-processor. The software processes the plurality of images and takes into account the respective location associated with each image such that the surface structure of the object can be visualised by the display.

### FIELD OF THE INVENTION

The present invention relates to system for visualising a surface structure and particularly, although not exclusively, to a system for producing a parametric image of an object.

### BACKGROUND OF THE INVENTION

The visualisation of a surface structure, such as the visualisation of a three-dimensional structure of an object or the visualisation of a surface structure that is difficult to see by the naked eye, has a range of important applications. For example, archaeological objects are often damaged and surface structures are difficult or impossible to see. Further, in forensic or criminal investigations surface structures may relate to important evidence such as imprints on blank pages of a book resulting from handwritten information on removed pages of the book.

Recently a technique has been developed that can be used to visualise such surface structures. Initially a number of images are taken either from different positions around an object having the surface structure or from one position with the object being illuminated from different directions. The camera position or illumination source positions are either recorded or predetermined and therefore known. Typically digital images are taken and the images are then processed by a computer.

The computer executes a texture mapping software, such as polynomial texture mapping (PTM) software. The software divides each image into a plurality of polygons taking into account the known positions of the camera(s) and/or light source(s) and generates a parametric image of the object that visualises the surface structure.

Typically a total 30 to 50 digital images are taken. For example, an arrangement supporting one or more cameras and a range of illumination sources around the object may be used for this purpose. Alternatively, a single camera or a single illumination source may be moved to predetermined positions around the object and the images may be taken in a sequential manner. In this case an arrangement is required that supports the camera or the illumination sources at the predetermined positions.

Further, it was recently proposed to place a reflective surface near the object and to use reflections from the reflective surface in each image to calculate the relative position of the camera and illumination source relative to the object. In this case it is not required to move the camera to the predetermined positions or to record the positions at which each image was taken by the camera.

Each of the described techniques has specific disadvantages. It is either required to have a particular arrangement for taking the images or it is required to record the camera position and/or illumination source position for each image. Alternatively, it is required to position a shiny surface near the object. Accordingly, there is a need for an advanced technical solution that addresses the above-described shortcomings.

### SUMMARY OF THE INVENTION

Briefly, the present invention provides a system for visualising a surface structure of an object. The system includes a camera for taking a plurality of images of the object and a location monitor for monitoring a respective location associated with each image that the camera takes. The system also includes a micro-processor, a display for displaying the surface structure of the object and a software routine for the micro-processor. The software processes the plurality of images and takes into account the respective location associated with each image such that the surface structure of the object can be visualised by the display.

The invention will be more fully understood from the following description of specific embodiments. The description is provided with reference to the accompanying drawings.

### BRIEF DESCRIPTION OF THE DRAWINGS

FIG. 1 is a schematic representation of a system for visualising a surface structure according to an embodiment of the invention;

FIG. 2 is a schematic representation of a system for visualising a surface structure according to another embodiment of the invention;

FIG. 3 is a schematic representation of a system for visualising a surface structure according to a further embodiment of the invention;

FIG. 4 is a flow-chart for a method embodiment of the invention;

FIG. 5 is a flow-chart for another method embodiment of the invention; and

FIG. 6 is a flow-chart for a further method embodiment of the invention.

### DETAILED DESCRIPTION OF EMBODIMENTS

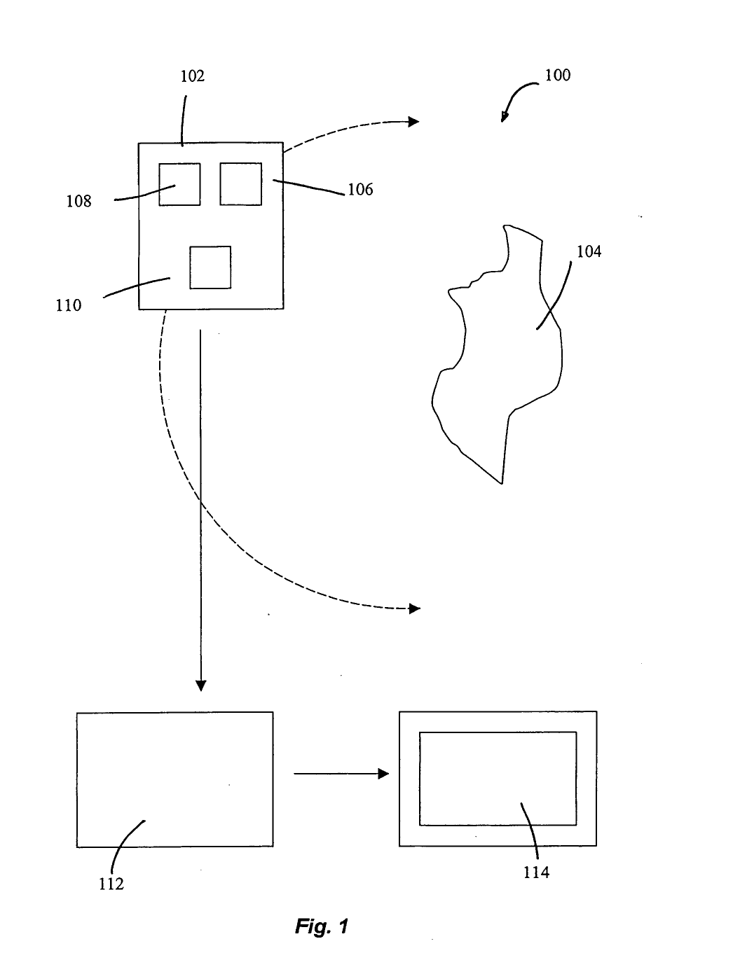

Referring initially to FIG. 1, a system for visualising a surface structure according to an embodiment of the invention is now described. FIG. 1 shows a system 100 which includes a housing 102 that is moveable around an object 104. The housing 102 includes a camera 106, a location monitor 108 and a light source 110.

The camera 106 takes an image of the object 104 at each of a plurality of positions around the object 104. At each location the location monitor 108 monitors the location of the housing 102 with the camera 106 and the light source 110. In this embodiment the camera 106 and the location monitor 108 are electronic devices and produce electronic data that is directed to personal computer 112 for processing. For example, the housing 102 with camera 106, location monitor 108 and light source 110 may be moveable by an operator and may be a hand-held device.

The object 104 may be an archaeological object or an object that is a subject of a forensic or criminal investigation. For example, the object 104 may have a plurality of faces and each face may have a structured surfaces which can be visualised using the system 100.

In this embodiment the personal computer 112 includes software for polynomial texture mapping (PTM). In operation, the software divides each of the plurality of images into a plurality of polygons. The software utilises the information from the location monitor and the different illumination levels of the polygons in different images to produce a texture mapping of the object and generates a parametric image on display 114. The system 100 has the significant advantage that the location monitor records the location of the housing 102 (including camera 106 and light source 110) and it is not necessary to use a complicated arrangement for supporting light sources and cameras around the object. Further it is not necessary to position a reflecting surface in the proximity of the object 104 or to manually record the position of the camera or of the light source. Therefore, system 100 significantly simplifies recording of images for generating parametric images and to visualise surface structures.

In a variation of the above-described embodiment the system 100 may be used to visualise a three-dimensional object. In this case the computer 112 may not include PTM software but may be equipped with software for calculating views of a three-dimensional model of the object from the image and location monitor data.

In a further variation of the embodiment shown in FIG. 1, the light source 110 may not be in one housing together with the camera 106. For example, the light source 110 may be positioned spaced apart from the camera 106 and may illuminate the object 104 from a stationary position when the camera 102 is moved around the object 104. Alternatively, the light source 110 may be moved independently from the camera 106.

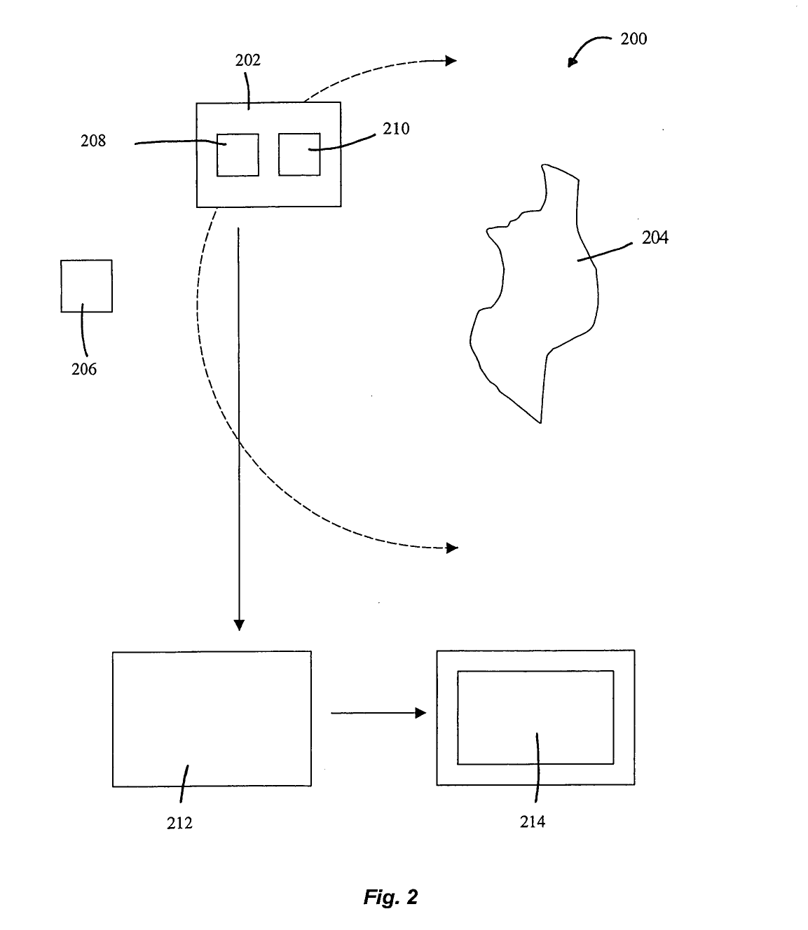

FIG. 2 shows a system 200 which includes a housing 202 that is moveable around an object 204. The housing 202 includes a location monitor 208 and a light source 210. The system also includes a camera 206 which in this embodiment is stationary. The camera 206 takes an image of the object 204 for each of a plurality of positions of the light source 210 around the object 204. The location monitor 208 monitors the location of the light source 210 for each position. In this embodiment the camera 206 and the location monitor 208 are electronic devices and produce electronic data that is directed to personal computer 212 for processing. The personal computer 212 includes software for polynomial texture mapping (PTM).

In operation, the software divides each image into a plurality of polygons. The software utilises the information from the location monitor and the different images to a produce a texture mapping and to generate a parametric image of the object on display 214. This embodiment has similar advantages as the embodiment shown in FIG. 1. It is not necessary to use a complicated arrangement for supporting light sources and cameras around the object 204, to position a reflecting surface in the proximity of the object 104 or to manually record the position of the camera or of the light source.

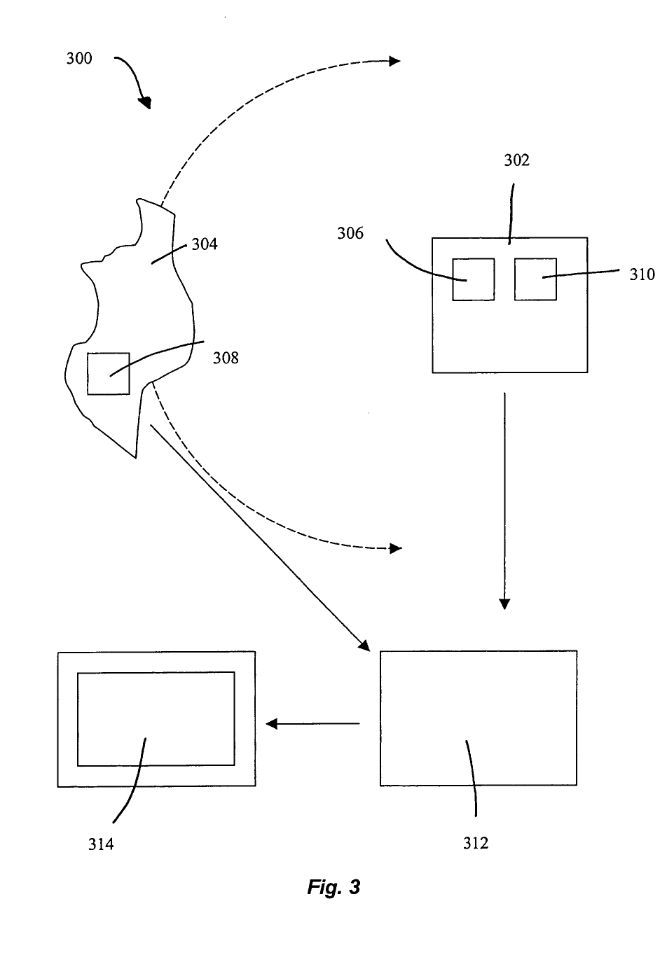

FIG. 3 shows system 300 which includes a housing 302 and an object 304 which is coupled to a location monitor 308. The object 304 with location monitor 308 is moveable around the housing 302 which includes a camera 306 and a light source 310. The camera 306 takes an image of the object 304 for each of a plurality of positions of the object 308 around the housing 302. At each location of the object 304 the location monitor 308 monitors the location of the object 304. In this embodiment the camera 306 and the location monitor 308 are electronic devices and produce electronic data that is directed to personal computer 312 for processing. The personal computer 312 includes software for polynomial texture mapping (PTM) and operates in the same manner as personal computers 112 and 212 shown in FIGS. 1 and 2 respectively and generates a parametric image on display 314.

Again, it is not necessary to use a complicated arrangement for supporting light sources and cameras around the object, to position a reflector surface in the proximity of the object 304 or to manually record the position of the camera or of the light source and taking images to generate a parametric image of an object therefor is significantly simplified.

The location monitors 108, 208 and 308 may include a GPS receiver for receiving Global Positioning System (GPS) signals. In use, the location monitor receives the GPS signals and generates electronic data for the approximate location. Additionally or alternatively, the location monitor 108, 208 and 308 may include a gyroscope such as an accelerometer which is used for the more precise determination of the location. An accelerometer typically measures acceleration by detecting an angular rate associated with a turning object. For example, the accelerometer may be a device that measures the angular rate using a capacitance system that may form a part of an integrated device.

The cameras 106, 206 and 306 are in this embodiment digital still-cameras. In a variation of these embodiments, video cameras may be used. The digital image data generated by the cameras 106, 206 and 306 are stored in a memory of the computer 112, 212 and 312, respectively together with the respective location data generated by the location monitors 108, 208 and 308.

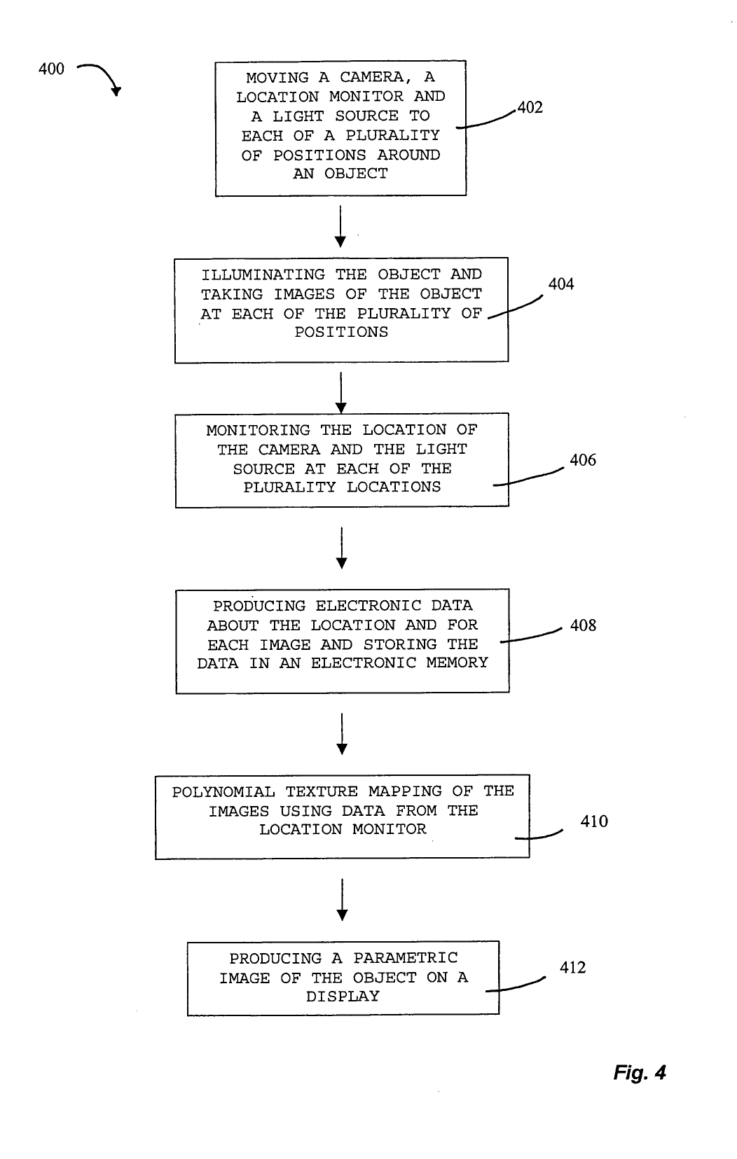

FIG. 4 shows a flow chart for a method embodiment of the invention which relates to the system embodiment shown in FIG. 1. The flow chart illustrates a method 400 of visualising a surface structure of an object. The method includes the step 402 of moving a camera, a light source and a location monitor to each of a plurality of positions around an object. The object is illuminated and images are taking at each position (step 404). The locations of the camera and the light source are monitored (step 406) and electronic data about the locations are stored in an electronic memory (step 408). The images are then processed using a PTM software routine which uses data from the location monitor (step 410) and a parametric image of the object is produced on a display (step 412).

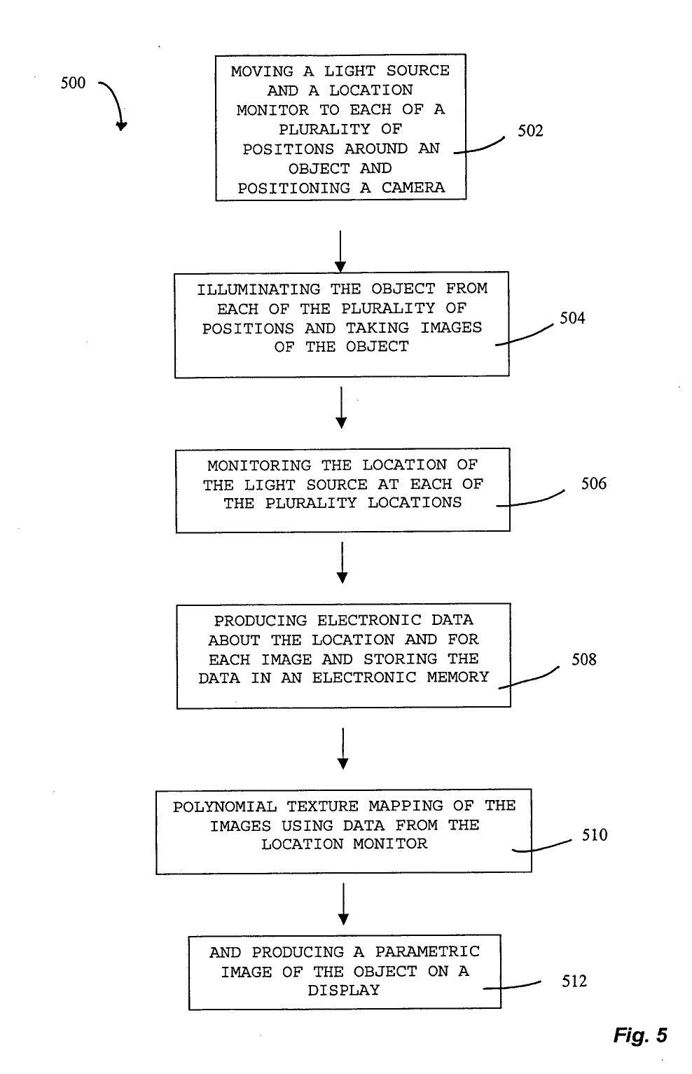

FIG. 5 shows a flow chart for another method embodiment of the invention which relates to the system embodiment shown in FIG. 2. The flow chart illustrates a method 500 which includes the step 502 of positioning a camera and moving a light source and a location monitor to each of a plurality of positions around an object. The object is illuminated and images are taking for each illumination condition (step 504). The location of the light source is monitored (step 506) and electronic data about the location are stored in an electronic memory (step 508). The images are then processed using a PTM software routine which uses data from the location monitor (step 510) and a parametric image of the object is produced on a display (step 512).

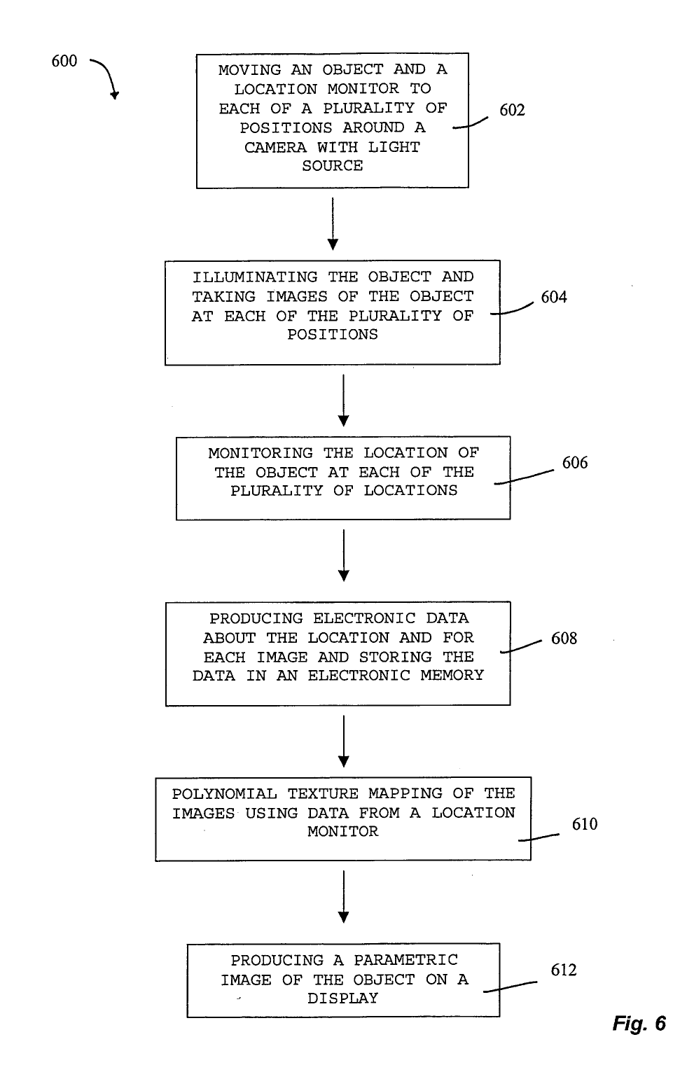

FIG. 6 shows a flow chart for a further method embodiment of the invention which relates to the system embodiment shown in FIG. 3. The flow chart illustrates a method 600 which includes the step 602 of moving an object with a location monitor to each of a plurality of positions around a camera with a light source. The object is illuminated and images are taking for each position of the object (step 604). The location of the object is monitored (step 606) and electronic data about the location are stored in an electronic memory (step 608). The images are then processed using a PTM software routine which uses data from the location monitor (step 610) and a parametric image of the object is produced on a display (step 612).

Although the invention has been described with reference to particular examples, those skilled in the art will appreciate it that the invention may be embodied in many other forms. For example, the system for visualising a surface structure may not include a housing such as housing 102, 202 and 302. The camera and the illumination source may be individually moveable. In this case both the camera and the illumination source may have an individual location monitor. Further, the system may not necessarily include an illumination source and natural light may be used for illumination. The computers 112, 212 and 312 may not be personal computers and may be replaced by processors that are positioned for example in a housing of the displays 114, 214 and 314. Alternatively, the processors may be positioned within the housings 102, 202 or 302.

As discussed above, the software may not necessarily be arranged for texture mapping but may be used to calculate a three-dimensional model of the object. In this case the software may calculate views of a three-dimensional model of the object from the image and location monitor data.

What is claimed is:

1. A system for visualising a surface structure of an object, the system comprising:
a camera for taking a plurality of images of the object;
a location monitor for monitoring a respective location associated with each image that the camera takes;
a micro-processor;
a display for displaying the surface structure of the object; and
a software routine for the micro-processor to process the plurality of images, taking into account the respective location associated with each image, such that the surface structure of the object can be visualised by the display.

2. The system of claim 1 wherein:
the location monitor is an electronic device that produces electronic data for the location of the camera when the camera takes each image at the respective location and the system comprises an electronic memory for storing the electronic data.

3. The system of claim 1 wherein:
the system comprises a illumination source for illuminating the object.

4. The system of claim 3 wherein:
the location monitor is an electronic device that produces electronic data for the location of the illumination source when the camera takes each image for a respective location of the illumination source and the system comprises an electronic memory for storing the electronic data.

5. The system of claim 1 wherein:
the location monitor and the camera are moveable around the object by a user of the system.

6. The system of claim 5 wherein:
the camera is a digital camera and electronic data generated by the digital camera are stored together with the electronic data for the location of the camera in the electronic memory.

7. The system of claim 3 wherein:
the location monitor with illumination source are moveable around the object by a user of the system.

8. The system of claim 1 wherein:
the location monitor comprises a gyroscope for monitoring the respective location associated with each image.

9. The system of claim 8 wherein:
the gyroscope comprises an accelerometer.

10. The system of claim 1 wherein:
the location monitor comprises a GPS receiver for monitoring the respective location associated with each image.

11. The system of claim 1 wherein:
the software routine allows polynomial texture mapping (PTM).

12. The system of claim 1 wherein:
the software routine divides in use each image into a plurality of polygons and the relative orientation of each polygon is calculated using data generated by the location monitor.

13. The system of claim 1 wherein:
the software routine produces in use a parametric image of the object that can be visualised by the display.

14. The system of claim 1 wherein:
the object and the location monitor are movable relative to the camera and the location monitor is an electronic device that produces electronic data for the location of the object when the camera takes each of the plurality of images.

15. The system of claim 14 wherein:
the system comprises an illumination source and the object with location monitor is moveable relative to the illumination source.

16. A system for visualising surfaces structure of an object, the system comprising:
a camera for taking images of the object at a plurality of locations and being moveable around the object;
an illumination source for illuminating the object;
a location monitor for monitoring a respective location of the camera for each image;
a micro-processor;
a display for displaying the surface structure of the object; and
a software routine for the micro-processor to process the plurality of images, taking into account the respective location of the camera for each image, such that a parametric image surface structure of the object is generated that can be visualised by the display.

17. A system for visualising a surface structure of an object, the system comprising:
a camera for taking images of the object;
an illumination source for illuminating the object and being moveable around the object;
a location monitor for monitoring a respective location of the illumination source for each image;
a micro-processor;
a display for displaying the surface structure of the object; and
a software routine for the micro-processor to process the plurality of images, taking into account the respective location of the illumination source for each image, such that a parametric image surface structure of the object is generated that can be visualised by the display.

18. A method of visualising a surface structure of an object, the method comprising steps of:
taking a plurality of images of the object;
monitoring a respective location associated with each image;
processing the plurality of images using a software routine that takes into account the respective location associated with each of the image, such that the surface structure of the object can be visualised by a display; and
displaying the surface structure of the object.

19. The method of claim 18 wherein:
the step of monitoring a respective location comprises monitoring the location of a camera and producing electronic data for the location of the camera when the camera takes each of the plurality of images.

20. The method of claim 18 wherein:
the step of monitoring a respective location comprises monitoring the location of an illumination source and producing electronic data for the location of the illumination source when a camera takes each of the plurality of images.

21. The method of claim 19 wherein:
the step of monitoring a respective location comprises storing electronic data in an electronic memory.

22. The method of claim 20 wherein:
the step of monitoring a respective location comprises storing electronic data in an electronic memory.

23. The method of claim 18 wherein:
the step of taking images of the object comprises illuminating the object when each image is taken.

24. The method of claim 18 wherein:
the step of taking images of the object comprises moving the camera with the location monitor to each of the plurality of the locations around the object.

25. The method of claim 18 wherein:
the step of taking images of the object comprises moving an illumination source with the location monitor to each of the plurality of the locations around the object.

26. The method of claim 18 wherein:
the step of taking images of the object at a plurality of locations comprises moving the object with the location monitor to each of the plurality of the locations.
